(19) United States
(12) Patent Application Publication
(10) Pub. No.: US 2008/0316584 A1
(43) Pub. Date: Dec. 25, 2008

(54) Optical device

(75) Inventors: Teruhiro Kubo, Kawasaki (JP); Yoichi Oikawa, Sapporo (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/213,464

(22) Filed: Jun. 19, 2008

(30) Foreign Application Priority Data
Jun. 21, 2007 (JP) 2007-163853

(51) Int. Cl. G02F 1/29

(52) U.S. Cl. 359/298

(57) ABSTRACT

According to an aspect of the embodiment, an optical device has a first optical element and a second optical element. The first optical element for inputting wavelength multiplexed light, the wavelength multiplexed light including a plurality of light channels which is arranged on predetermined frequency interval, the first optical element outputting an angular dispersion light in parallel, the angular dispersion light being arranged positions of the light channels on different interval spaces, respectively. The second optical element for receiving the angular dispersion light from the first optical element and for changing positions in accordance with the light channels on different interval spaces into on predetermined interval space.

### BACKGROUND

1. Field

This art relates to an optical device. For example, the optical device includes an angular dispersion device performing for disperse wavelength multiplexed light.

2. Description of the Related Art

Recently, high-speed access networks with a band of about several Mbit/s to 100 Mbit/s, for example, FTTH (Fiber To The Home) and ADSL (Asymmetric Digital Subscriber Line) have spread rapidly. Due to these high-speed access networks, an environment in which one can enjoy a broadband Internet service is being improved. To keep up with increasing telecommunications demand, in backbone networks (core networks), an extra large capacity optical communication system using WDM (Wavelength Division Multiplexing) technology is being laid.

On the other hand, at the junction between a metro network and a core network, there is concern that a band bottleneck may occur due to the limit of electric switching capability. Accordingly, there are energetically carried out research and development of a new photonic network architecture in which a new optical switching node is provided in the metro region where a band bottleneck occurs, and a metro network that users directly access and a core network are directly connected in an optical region without providing an electric switch therebetween.

Optical switching nodes that connect a core network and a metro network include a wavelength selective switch (see, for example, Patent Document 1). In a wavelength selective switch, input multiplexed light is wavelength-demultiplexed, and each wavelength of light is output to a desired output port.

FIG. 6 illustrates optical demultiplexing of a known wavelength selective switch. As shown, the wavelength selective switch includes an angular dispersive element 101 and MEMS (Micro Electro Mechanical System) mirrors 102a to 102d.

Wavelength-multiplexed light 111 is input into the angular dispersive element 101. The angular dispersive element 101 has a relationship of θ∝λ (θ: the angle of output light, λ: wavelength). The angular dispersive element 101 inputs the input light 111 and outputs angular dispersion light in accordance with wavelength.

The angular dispersion light beams 112a to 112d outputted from the angular dispersive element 101 are inputted to the MEMS mirrors 102a to 102d that are arranged one-dimensionally.

The MEMS mirrors 102a to 102d are minute mirrors whose angles are variable. The MEMS mirrors 102a to 102d reflect the light beams 112a to 112d output from the angular dispersive element 101 in desired angular directions and guide them to a plurality of output optical ports (not shown) disposed in the angular directions.

According to the regulation of ITU (International Telecommunication Union), the frequency interval spacing of WDM channels is 100 GHz or 50 GHz. In terms of wavelength, the wavelength interval spacing is not equal.

FIG. 7 shows the relationship between frequencies of WDM. The horizontal axis of the graph represents frequency, and the vertical axis represents intensity of light. As described above, in WDM defined by ITU, the light channels of WDM are set on equal frequency space.

FIG. 8 shows the relationship between wavelengths of WDM. The horizontal axis of the graph represents wavelength, and the vertical axis represents intensity of light. As shown in FIG. 7, in WDM defined by ITU, the light channels of WDM are set at equal spacings. Therefore, the wavelengths are at unequal wavelength spaces as shown in FIG. 8.

As illustrated in FIG. 6, the angular dispersive element 101 has the relationship of θ∝λ. The angular dispersive element 101 disperses the inputted wavelength-multiplexed light into angular dispersion light in accordance with wavelength. Since the wavelength interval spacing of the wavelength multiplexed light are unequal as shown in FIG. 8. The wavelength interval spaces between wavelengths outputted from the angular dispersive element 101 are unequal as shown by arrows A101 of FIG. 6.

Japanese Laid-open Patent Publication No. 2006-284740 discusses that an angular dispersive element is used the optical device.

Since the light channels of WDM is unequal as described above. The light beams output from the angular dispersive element are at unequal space. Therefore, the spaces between, for example, mirrors that reflect the wavelength-dispersed light beams need to be unequal. This lowers the yield.

### SUMMARY

An object of an aspect of the present invention is to provide an optical device that can change positions of light channels.

According to an aspect of the embodiment, an optical device has a first optical element and a second optical element.

The first optical element for inputting wavelength multiplexed light, the wavelength multiplexed light including a plurality of light channels which is arranged on predetermined frequency interval, the first optical element outputting an angular dispersion light in parallel, the angular dispersion light being arranged positions of the light channels on different interval spaces, respectively.

The second optical element for receiving the angular dispersion light from the first optical element and for changing positions in accordance with the light channels on different interval spaces into on predetermined interval space.

Additional objects and advantages of the invention will be set forth in part in the description which follows, and in part will be obvious from the description, or may be learned by practice of the invention. The object and advantages of the invention will be realized and attained by means of the elements and combinations particularly pointed out in the appended-claims.

It is to be understood that both the foregoing general description and the following detailed description are exemplary and explanatory only and are not restrictive of the invention, as claimed.

### BRIEF DESCRIPTION OF THE DRAWINGS

FIG. 1 shows the outline of an optical wavelength demultiplexer.

FIG. 2 is a perspective view of a wavelength selective switch.

FIG. 3 shows the wavelength selective switch of FIG. 2 viewed from the X direction.

FIG. 4 shows the wavelength selective switch of FIG. 2 viewed from the Y direction.

FIG. 5 is a perspective view of a performance monitor.

FIG. 6 illustrates optical demultiplexing of a known wavelength selective switch.

FIG. 7 shows the relationship between frequencies of WDM.

FIG. 8 shows the relationship between wavelengths of WDM.

### DETAILED DESCRIPTION OF THE PREFERRED EMBODIMENT

The embodiments will now be described with reference to the drawings in detail.

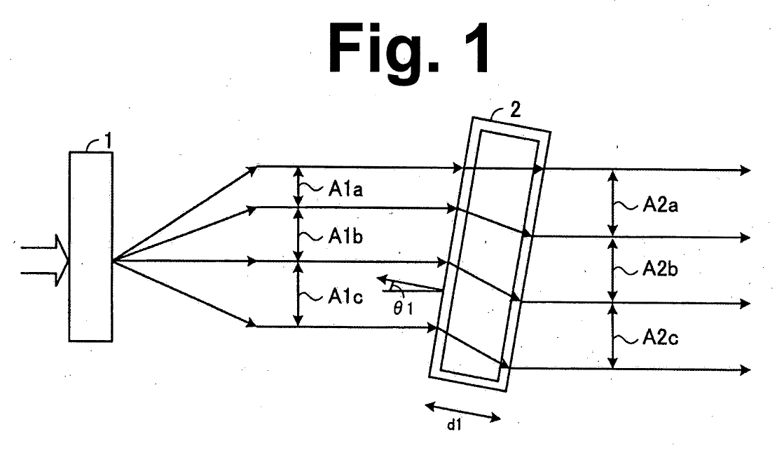

FIG. 1 shows the outline of an optical wavelength demultiplexer. As shown, the optical wavelength demultiplexer includes a first dispersion element 1 and a second dispersion element 2.

A wavelength multiplexed light includes a plurality of light channels which are arranged on predetermined frequency interval in accordance with ITU-T standard.

The first dispersion element 1 inputs a wavelength multiplexed light. The each light channels in wavelength multiplexed light is set on equally frequency interval on the frequency axis and on unequally wavelength interval on the wavelength axis.

The first dispersion element 1 outputs a beam which is an angular dispersion light to each of the light channels in the wavelength multiplexed light. The first dispersion element 1 has a relationship of θ∝λ. The first dispersion element 1 outputs angular dispersion light in accordance with the wavelength of the light channels. The light channels of the outputted angular dispersion light from the first dispersion element 1 are arranged on unequal interval space as shown by arrows A1a to A1c in the FIG. 1 because the wavelengths of the light channels in wavelength multiplexed light are unequal spaced on the wavelengths axis. The first dispersion element 1 includes, for example, a diffraction grating.

Light beam outputted from the first dispersion element 1 is inputted into the second dispersion element 2. The second dispersion element 2 is an element whose refractive index varies depending on the wavelength, for example, a lens made of fluorite. The second dispersion element 2 changes unequal interval spaces between the light channels from the first dispersion element 1 into equal interval spaces between the light channels as shown by arrows A2a to A2c in the FIG. 1, and outputs them. Specifically, the thickness (d1 in the FIG. 1) of the second dispersion element 2 and the angle (θ1 in the FIG. 1) of incident with the surface of the second dispersion element 2, are adjusted so as to output the light channels with equal interval spaces.

As described above, in the optical wavelength demultiplexer has the first dispersion element 1 and the second dispersive element 2. The first dispersion element 1 disperses wavelength multiplexed light into angular dispersion light in accordance with each wavelength of light channels.

The second dispersive element 2 changes positions of the light channels of the angular dispersion light outputted from the first dispersion element 1 into equally interval spaced positions.

Therefore, if the light channels of WDM light outputted from the first dispersion element 1 have unequal spaces, the light channels of WDM light can be equally spaced by the second dispersion element 2.

Next, a first embodiment of the present invention will be described with reference to the drawings in detail. In the first embodiment, an example in which an optical wavelength demultiplexer is applied to a wavelength selective switch will be described.

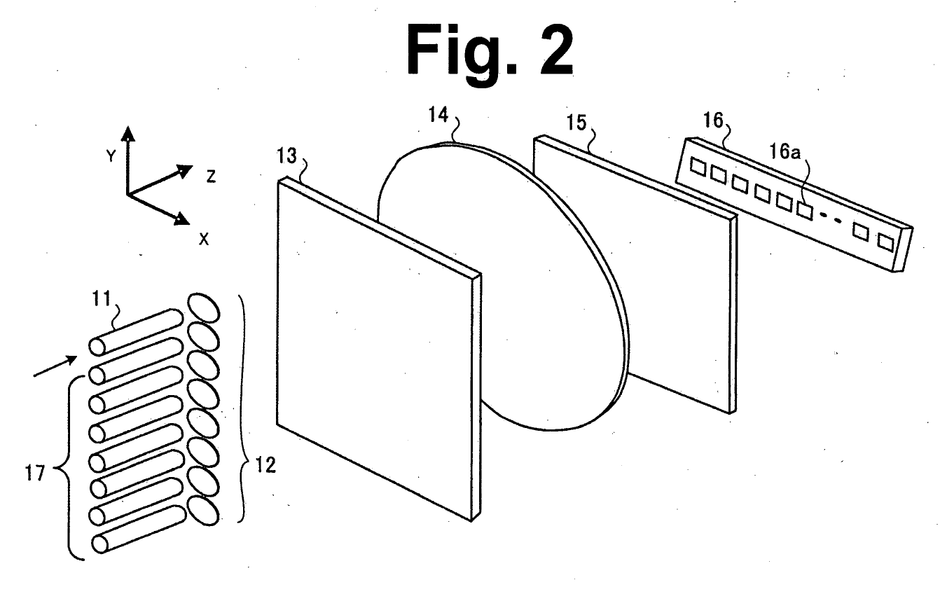

FIG. 2 is a perspective view of a wavelength selective switch. As shown, the wavelength selective switch includes an input fiber 11, a lens array 12, an angular dispersive element 13, a convex lens 14, an anomalous dispersion element 15, an MEMS substrate 16, and output fibers 17.

The input fiber 11 and the output fibers 17 are arranged in the Y direction. Wavelength-multiplexed light is input into the input fiber 11. The light is output to the lens of the lens array 12 assigned to the input fiber 11.

The lenses of the lens array 12 are arranged to the input fiber 11 and the output fibers 17. The lenses of the lens array 12 collimate diffused, light and output the collimated light.

A lens of the lens array 12 in combination with input fiber 11 collimates diffused light from the input fiber 11 and outputs the collimated light. The outputted light from the lens in combination with input fiber 11 is imputed into the angular dispersive element 13.

Lenses of the lens array 12 in combination with output fibers. 17 input light beams reflected by the MEMS substrate 16, respectively. The lenses in combination with the output fibers 17 collimates diffused light beams from the MEMS substrate 16 and output the collimated light toward the output fibers 17.

In FIG. 2, the first dispersion element 1 as shown in FIG. 1 may includes angular dispersion element 13 and lens 14.

The angular dispersion element 13 is, for example, a diffraction grating. The angular dispersion element 13 input the wavelength-multiplexed light outputted from the input fiber 11. The angular dispersion element 13 has a relationship of θ∝λ, disperses the wavelength multiplexed light and outputs the inputted the wavelength multiplexed light. The spread direction of angular dispersion light is a mirrors arrangement direction on the MEMS substrate 16. The dispersed light beams from the angular dispersion element 13 are inputted into the convex lens 14.

The convex lens 14 focuses beams of the angular dispersion light in accordance with wavelength of light channel onto the MEMS substrate 16.

The light beams outputted from the angular dispersion element 13 are inputted into the anomalous dispersion element 15 through the convex lens 14. The anomalous dispersion element 15 is made, for example, of fluorite. The anomalous dispersion element 15 corrects the unequal interval space positions of the light channels become equal interval space positions. The anomalous dispersion element 15 outputs the corrected light to the MEMS substrate 16.

The MEMS substrate 16 includes a plurality MEMS mirrors 16a. The plurality MEMS mirrors 16a is arranged one dimensional and equally-spaced interval on the MEMS substrate 16. The MEMS substrate 16 includes a mechanism that varies the angles of the MEMS mirrors 16a in accordance, for example, with control signals. The MEMS substrate 16 can reflect inputted light beams to desired ones of the output fibers 17.

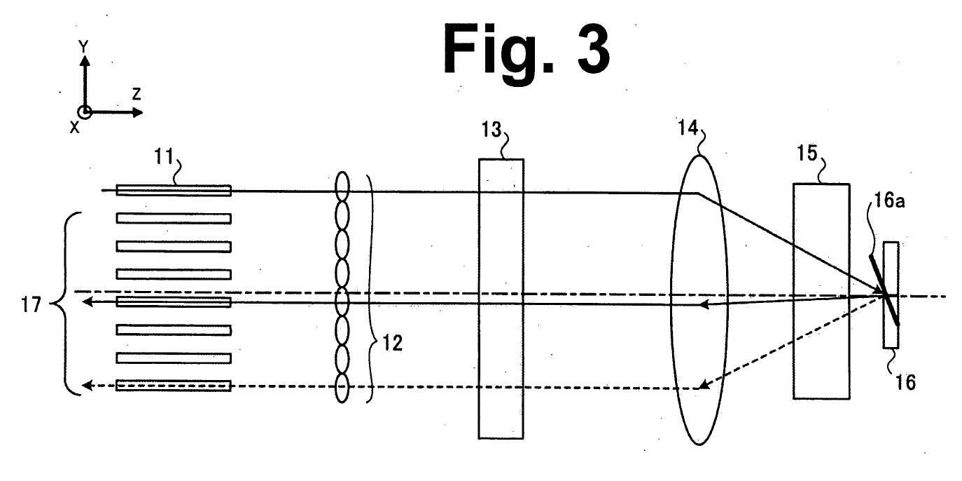

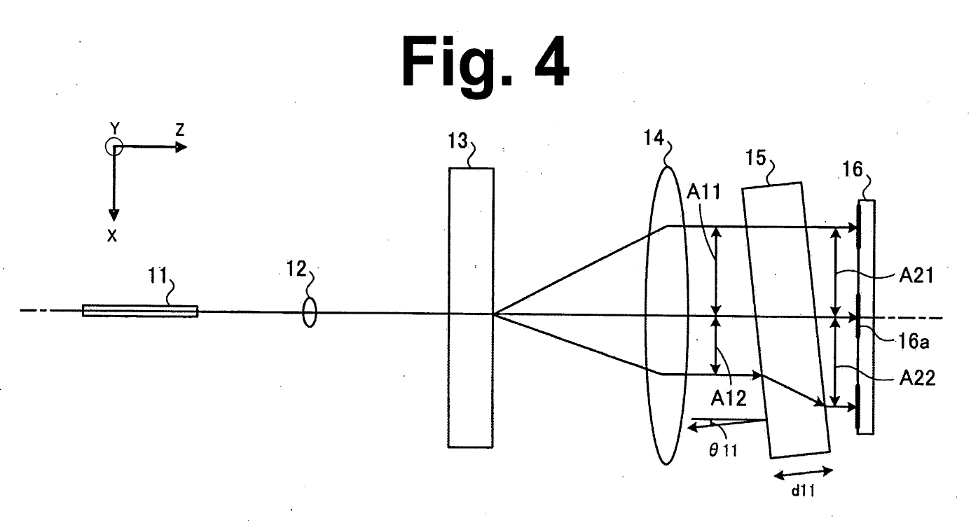

FIG. 3 shows the wavelength selective switch of FIG. 2 viewed from the X direction. FIG. 4 shows the wavelength selective switch of FIG. 2 viewed from the Y direction. In FIGS. 3 and 4, the same reference numerals will be used to designate the same components as those in FIG. 2, so that the description thereof will be omitted.

The wavelength multiplexed light is outputted from the input fiber 11. The wavelength multiplexed light is inputted into the lens of the lens array 12 corresponding to the input fiber 11. The lens of the lens array 12 restrains the divergence of light output from the input fiber 11, collimates the light outputted from the input fiber 11, and outputs the collimated light to the angular dispersive element 13.

As shown in FIG. 4, the angular dispersive element 13 provides the angular dispersion in accordance with wavelength of the inputted the wavelength multiplexed light.

The convex lens 14 focuses the angular dispersion light beams from the angular dispersive element 13 onto the MEMS substrate 16.

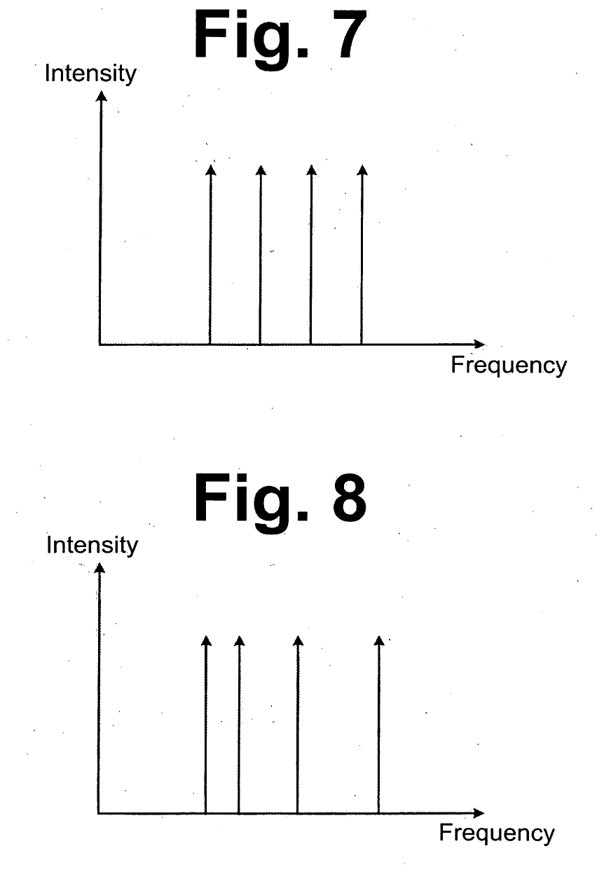

As illustrated in FIGS. 7 and 8, since frequencies of the light channels are set at equal frequency interval space on frequency axis, therefore the light channels are on unequal wavelength interval space on wavelength axis. Since the angular dispersive element 13 has the relationship of θ∝λ as described above, when the wavelengths (λ) are unequally wavelength spaced, the angles (θ) of light beams output from the angular dispersive element 13 are also unequally angles between each light channels. Therefore, the light beams output from the angular dispersive element 13 and focused by the convex lens 14 are unequally spaced as shown by arrows A11 and A12 of FIG. 4.

The anomalous dispersion element 15 corrects the unequally-spaced light beams output from the angular dispersive element 13 through the convex lens 14 so that they become equally spaced. Specifically, the anomalous dispersion element 15 is substantially a rectangular parallelepiped in shape. The anomalous dispersion element 15 is adjusted its thickness (d11 in FIG. 4) and the angle (θ11 in FIG. 4) to the normal to the surface on which light beams fall. The anomalous dispersion element 15 performs to correct input light so that beam positions of light channels are arranged on desired equal interval spaces (the spaces between the MEMS mirrors 16a of the MEMS substrate 16). In this way, light beam in accordance with the light channels passing through the anomalous dispersion element 15 are corrected so as to be equally spaced as shown by arrows A21 and A22 of FIG. 4.

The light beams outputted from the anomalous dispersion element 15 are reflected by the MEMS mirrors 16a of the MEMS substrate 16. The MEMS mirrors 16a can vary their angles and can output light beams input from the input fiber 11 to target ones of the output fibers 17. For example, as shown in FIG. 3, the MEMS mirrors 16a can reflect input light beams as shown by a solid arrow or a dashed arrow in the figure by varying their angles and can output them to target ones of the output fibers 17.

The light beams reflected by the MEMS mirrors 16a are refracted by the convex lens 14 so as to be parallel to the Z axis, pass through the angular dispersive element 13, and are inputted into the lens array 12. The lens array 12 collimates divided light beams and output them to the output fibers 17.

In this way, in the wavelength selective switch has angular dispersive element 13, the anomalous dispersion element 15, MEMS mirrors 16a and the output fibers 17.

The angular dispersive element 13 disperses a wavelength multiplexed light into an angular dispersion light in accordance with the wavelength of the light channels. The anomalous dispersion element 15 outputs the angular dispersion light beam on equally interval spaces. The pluralities of MEMS mirrors 16a reflect the angular dispersion light beam to ones of the output fibers 17.

Therefore, the angular dispersive element 13 outputs light on unequal spaces in accordance with the wavelength of the light channels but the anomalous dispersion element 15 corrects light beam positions in equally interval spaces in accordance with the wavelength of the light channels, and the anomalous dispersion element 15 outputs the light beams to the plurality of MEMS mirrors 16a.

Therefore, the plurality of MEMS mirrors 16a can be formed at equal space, and the yield of the MEMS substrate 16 can be improved.

Next, a second embodiment will be described with reference to the drawings in detail. In the first embodiment, an example in which an optical wavelength demultiplexer is applied to a wavelength selective switch is described, whereas in the second embodiment, an example in which an optical wavelength demultiplexer is applied to a performance monitor will be described.

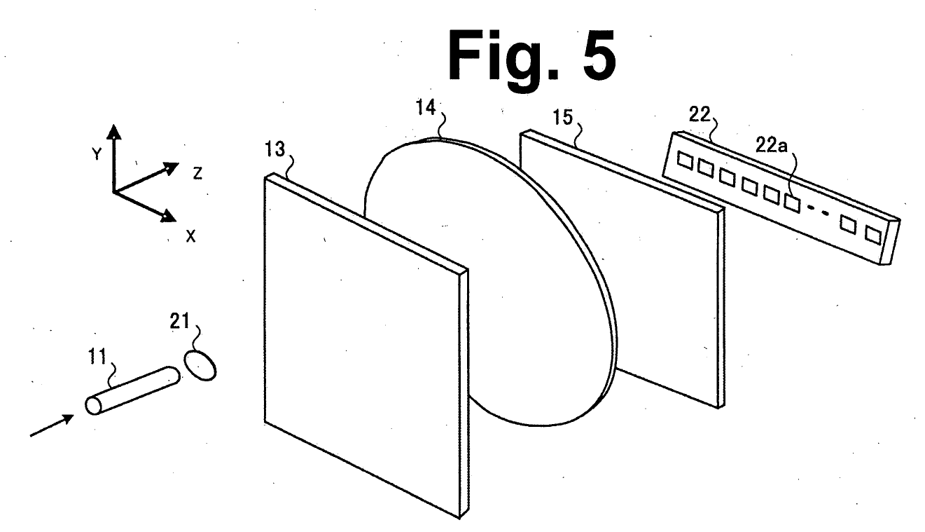

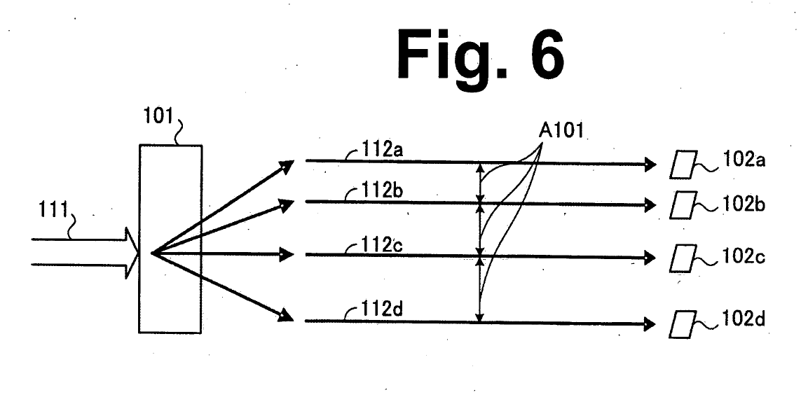

FIG. 5 is a perspective view of a performance monitor. A performance monitor is a device that can measure the light intensity of each wavelength of wavelength-multiplexed light. In FIG. 5, the same reference numerals will be used to designate the same components as those in FIG. 2, so that the description thereof will be omitted.

Compared to the wavelength selective switch of FIG. 2, the performance monitor of FIG. 5 does not include the output fibers 17 and includes a lens 21 instead of the lens array 12. In addition, it includes, instead of the MEMS substrate 16, a light monitor substrate 22 that detects the intensity of light. The light monitor substrate 22 includes a plurality of one-dimensionally equally-spaced PDs (Photo Diodes) 22a.

Light output from the input fiber 11 is input into the angular dispersive element 13 through the lens 21. The light input into the angular dispersive element 13 is angularly wavelength-dispersed and output to the convex lens 14. The convex lens 14 focuses wavelengths of light output from the angular dispersive element 13 onto the light monitor substrate 22.

The anomalous dispersion element 15 corrects the unequally-spaced light beams output from the angular dispersive element 13 through the convex lens 14 so that they become equally spaced, and outputs them to the light monitor substrate 22. Specifically, the anomalous dispersion element 15 is substantially a rectangular parallelepiped in shape. Specifically, the anomalous dispersion element 15 is substantially a rectangular parallelepiped in shape. The anomalous dispersion element 15 is adjusted its thickness and the angle to the normal to the surface on which light beams fall. The anomalous dispersion element 15 performs to correct input light so that beam positions of light channels are arranged on desired equal interval spaces (the spacings between the PDs 22a of the light monitor substrate 22).

The PDs 22a of the light monitor substrate 22 convert equally-spaced light beams, output from the anomalous dispersion element 15 into electric currents. By measuring the electric currents output from the PDs 22a, the light intensity of each wavelength of wavelength-multiplexed light can be measured.

In this way, in the performance monitor, the wavelength-multiplexed light is angularly wavelength-dispersed by the angular dispersive element 13, and the angularly-dispersed wavelengths of light are equally spaced and output by the anomalous dispersion element 15. The intensities of equally-spaced wavelengths of light output from the anomalous dispersion element 15 are measured by the plurality of PDs 22a.

Therefore, if wavelengths of light are output from the angular dispersive element 13 at unequal spacings, they are equally spaced by the anomalous dispersion element 15 and are input into the plurality of PDs 22. Therefore, the plurality of PDs 22a can be formed at equal spacings, and the yield of the light monitor substrate 22 can be improved.

What is claimed is:

1. An optical device comprising:
a first optical element for inputting wavelength multiplexed light, the wavelength multiplexed light including a plurality of light channels which is arranged on predetermined frequency interval, the first optical element outputting an angular dispersion light in parallel, the angular dispersion light being arranged positions of the light channels on different interval spaces, respectively; and
a second optical element for receiving the angular dispersion light from the first optical element and for changing positions in accordance with the light channels on different interval spaces into on predetermined interval space.

2. The optical device of claim 1, wherein the second optical element has a first surface, a second surface parallel to the first surface and a refractive index, the second optical element slantingly arranged to the angular dispersion beam.

3. The optical device of claim 1, wherein the second optical element is fluorite.

4. The optical device of claim 1, wherein the first optical element is diffraction grating.

5. The optical device of claim 1, further comprising a reflector for receiving an outputted light from the second optical element and for reflecting the received outputted light to the second optical element.

6. The optical device of claim 1, further comprising a detector for receiving an outputted light from the second optical element and for detecting a power of the each light channels.
